(19) United States
(12) Patent Application Publication
(10) Pub. No.: US 2009/0250496 A1
(43) Pub. Date: Oct. 8, 2009

(54) Fish'n go fish rod holder for bikes

(76) Inventor: Truman Scott Freyberger, Reading, PA (US)

Correspondence Address: TRUMAN S. FREYBERGER, 1991 MT. LAUREL RD., FLEETWOOD, PA, 19522, US

(21) Appl. No.: 12/383,794

(22) Filed: Mar. 30, 2009

Related U.S. Application Data
(60) Provisional application No. 61/042,134, filed on Apr. 3, 2008.

(51) Int. Cl. B62J 11/00

(52) U.S. Cl. 224/427

(57) ABSTRACT

Fishing rod holder FIG. 1 designed for safe transport of fishing rods. User has easy accessibility for loading and unlading fishing rods 18. as well as accessibility for placement of fishing gear 22. User has choice for placement of rod holder and accessory box to either main bike seat or passenger seat. Fishing rod holder FIG. 1. is specifically geared for safety the user can safely ride bike with out having to hold their fishing rods and gear while on bike.

### CROSS-REFERENCE TO RELATED APPLICATIONS

This application claims the benefit of provisional patent application no. 61/042,134 filed 2008 Apr. 3

### FEDERALLY SPONSORED RESEARCH

Not Applicable

### SEQUENCE LISTING

Not Applicable

### BACKGROUND OF INVENTION

Pole holder has accessory box attached to it which can be taken off support frame and attached to passenger seat.

Can have down rigger attached for more weight and support.

### DETAILED DESCRIPTION

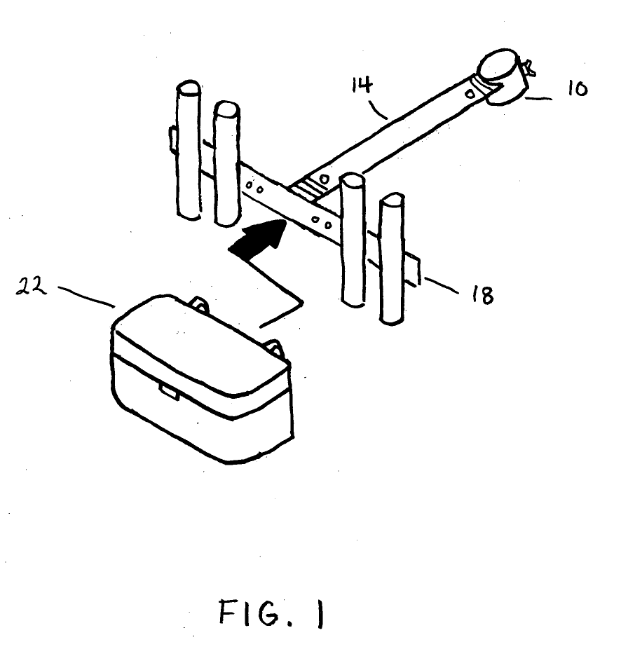

FIG. 1 shows the Fish'n Go as a whole that can be cast from a mold and made of a durable plastic which can be easily removed or of tubular and flat metal and dismanted 10 the seat clamp which can be permanently be placed on the bike.

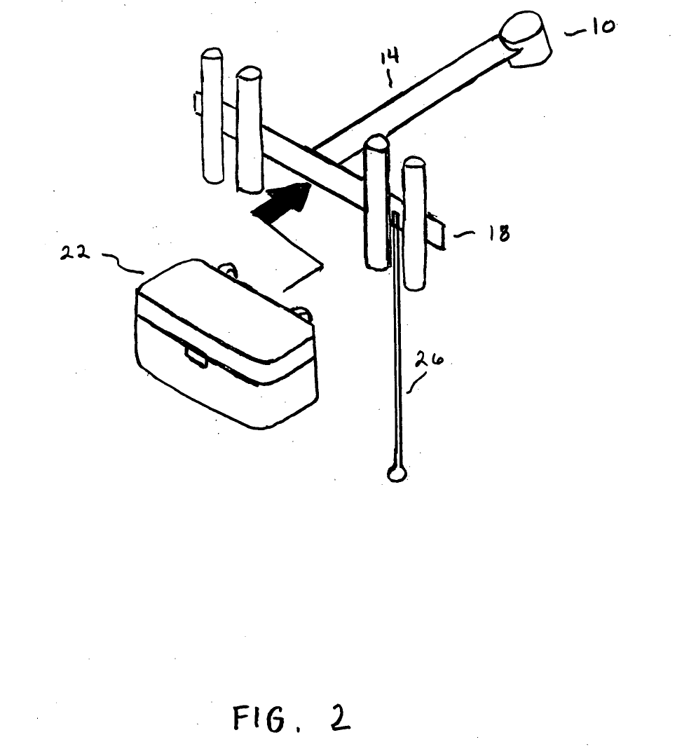

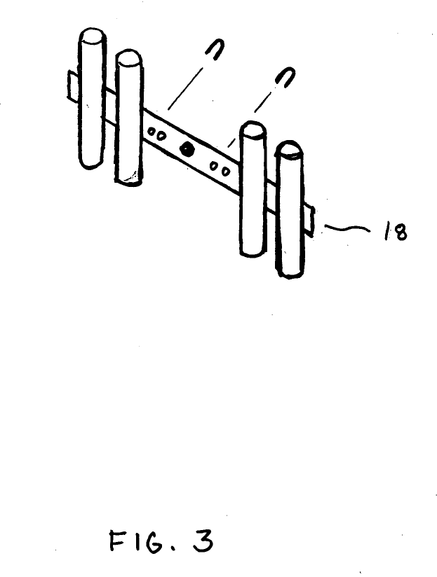

14 is the support frame that fits into 10 and tightens down with a bolt. 18. FIG. 3. Then slips over 14 and tightens down with a bolt. 26. FIG. 3. can then be added to either side of 18 for extra weight and support then 22 FIG. 2. would slip over 18 to put accessories in. 18 and 22 can be removed to clamp down onto back of passenger seat.

### SUMMARY

The Fish'n Go is for safety transport of carrying fishing rods and accessories on bicycles or motorized bikes. Can be taken apart and used in different ways depending on the bike.

FIG. 1 shows a whole unit, the seat clamp would attach on the shaft of the seat.

FIG. 2 Down Riggers attached for extra weight and support.

FIG. 3 Pole holder and accessory box can be attached to a passenger seat.

### REFERENCE NUMERALS

10 Seat clamp
14 Support frame
18 Pole holder
22 Accessory box
26 Down riggers/support

I claim:

1. A device to safely carry fishing rods on a bike, comprising:
(A) A mountable apparatus that clamps to shaft of bike seat of passenger seat,
(B) That can be easily attached or removed,
(c) Sear clamp remains permanently on sear shaft; the down rigger attaches to axis nuts up to pole holder for extra weight and support.
